(19) United States
(12) Patent Application Publication
(10) Pub. No.: US 2026/0040045 A1
(43) Pub. Date: Feb. 5, 2026

(54) VEHICLE, A SERVICE PROVIDING METHOD THEREOF, AND A VEHICLE SERVICE PROVIDING SYSTEM AND METHOD INCLUDING SAME

(71) Applicants: HYUNDAI MOTOR COMPANY, Seoul (KR); KIA CORPORATION, Seoul (KR)

(72) Inventor: Jae Yoon Ko, Hwaseong-si (KR)

(73) Assignees: HYUNDAI MOTOR COMPANY, Seoul (KR); KIA CORPORATION, Seoul (KR)

(21) Appl. No.: 18/952,649

(22) Filed: Nov. 19, 2024

(30) Foreign Application Priority Data
Aug. 2, 2024 (KR) 10-2024-0103319

(51) Int. Cl. H04W 4/40; G06Q 50/40

(52) U.S. Cl. CPC H04W 4/40; G06Q 50/40

(57) ABSTRACT

A vehicle, a service providing method thereof, and a vehicle service providing system and method including the same that are realized to provide a service are disclosed. The vehicle includes a first vehicle terminal and a second vehicle terminal. The first vehicle terminal is configured to communicate with a service server and provide the second vehicle terminal with service subscription information received from the service server by request according to a preset situation. The second vehicle terminal is configured to communicate with a content server. The second vehicle terminal is configured to determine whether a service for the vehicle is subscribed to, based on the service subscription information in response to a determination that there is a service request. The second vehicle terminal is configured to provide a connected-car service based on communication with the content server in response to a determination that the service is subscribed to.

### CROSS REFERENCE TO RELATED APPLICATION

The present application claims the benefit of and priority to Korean Patent Application No. 10-2024-0103319, filed on Aug. 2, 2024, the entire contents of which are incorporated by reference herein for all purposes.

### TECHNICAL FIELD

The present disclosure is related to a vehicle and more particularly is related to a vehicle, a service providing method thereof, and a vehicle service providing system and method including the same that are used to provide a service.

### BACKGROUND

Recently, a vehicle has been used to provide various services based on communication with a server connected via a communication network. This vehicle may be referred to as a “connected car”. The connected car is equipped with at least one vehicle terminal for providing various services to achieve objectives of the connected car.

In order for a vehicle to provide a service, a service subscription and a service opening are required. If a user wants to use the service without a service subscription and a service opening, the vehicle gives the user guidance on the service subscription.

Service subscription guidance information is stored in a vehicle terminal, and the vehicle terminal gives, based on the pre-stored subscription guidance information, guidance on a service subscription.

Therefore, because the vehicle terminal gives guidance on a service subscription based on the pre-stored service subscription guidance information, if the service subscription guidance information is changed, the vehicle terminal is unable to provide the changed service subscription guidance information.

The software of the vehicle terminal may be changed to provide the latest service subscription guidance information, but the software of the vehicle terminal needs to be changed every time the service subscription guidance information is changed. Thus, development and maintenance costs are increased. Therefore, there is a need for an efficient way for a vehicle terminal to provide the latest service subscription guidance information.

The background section provides technical information that the applicant had when the present disclosure is derived or that the applicant acquired in the process of deriving the present disclosure. However, the technical information cannot necessarily be referred to as technology that was well known to the public before the filing of the application for the present disclosure. The subject matter described in this background section is intended to promote an understanding of the background of the disclosure and thus may include subject matter that is not already known to those of ordinary skill in the art.

### SUMMARY

The present disclosure aims to address the above problems occurring in the related art. The present disclosure provides a vehicle, a service providing method thereof, and a vehicle service providing system and method including the same that are capable of providing the latest service subscription guidance information efficiently.

The present disclosure provides a vehicle, a service providing method thereof, and a vehicle service providing system and method including the same that are capable of providing the latest service subscription guidance information without changing the software of an infotainment terminal.

The present disclosure provides a vehicle, a service providing method thereof, and a vehicle service providing system and method including the same that are capable of providing the latest service subscription guidance information without direct link between an infotainment terminal and a service server. The vehicle, the service providing method thereof, and the vehicle service providing system and method including the same may provide the infotainment terminal with service subscription information and service subscription guidance information received by making a request to a service server for the service subscription information every time a connected car terminal is reset.

The present disclosure provides a vehicle, a service providing method thereof, and a vehicle service providing system and method including the same that are capable of providing a connected-car service or giving service subscription guidance based on service subscription information and service subscription guidance information received. The vehicle, the service providing method thereof, and the vehicle service providing system and method including the same may make a request to a connected car terminal for the service subscription information from an infotainment terminal when a connected-car service request is received while a service is not subscribed to.

It should be understood that technical problems to be solved by the present disclosure are not limited to the aforementioned technical problems. Other technical problems, which are not mentioned, should be apparent from the following descriptions to those having ordinary skill in the art to which the present disclosure pertains.

To solve the technical problems, a vehicle, a service providing method thereof, and a vehicle service providing system and method including the same that are realized to provide a service are provided.

According to an embodiment of the present disclosure, a vehicle includes a first vehicle terminal and a second vehicle terminal. The first vehicle terminal is configured to communicate with a service server. The first vehicle terminal is configured to provide the second vehicle terminal with service subscription information received from the service server by request according to a preset situation. The second vehicle terminal is configured to communicate with a content server. The second vehicle terminal is configured to determine whether a service for the vehicle is subscribed to, based on the service subscription information in response to a service request. The second vehicle terminal is configured to provide a connected-car service based on communication with the content server in response to a determination that the service is subscribed to.

According to an embodiment, the second vehicle terminal may be configured to make a request to the first vehicle terminal for the service subscription information in response to a determination that the service is not subscribed to.

According to an embodiment, the first vehicle terminal may be configured to request the service subscription information to the service server in response to the request of the second vehicle terminal and provide the second vehicle terminal with the service subscription information received from the service server by request. The second vehicle terminal may be further configured to determine whether the service is subscribed to, based on the service subscription information.

According to an embodiment, the second vehicle terminal may be configured to provide the connected-car service based on plan information included in the service subscription information in response to a determination that the service is subscribed to. The second vehicle terminal may be configured to give guidance on a service subscription based on service subscription guidance information included in the service subscription information in response to a determination that the service is not subscribed to.

According to an embodiment, the first vehicle terminal may be configured to make a request to the service server for the service subscription information in response to a reset. The first vehicle terminal may be configured to receive the service subscription information from the service server by request. The first vehicle terminal may be configured to provide the received service subscription information to the second vehicle terminal.

According to an embodiment, a service providing method of a vehicle includes determining, by a second vehicle terminal of the vehicle, whether a service for the vehicle is subscribed to in response to a service request. The service providing method further includes providing, by the second vehicle terminal, a connected-car service based on communication with a content server in response to a determination that the service is subscribed to. The service providing method further includes making, by the second vehicle terminal, a request to a first vehicle terminal of the vehicle for service subscription information in response to a determination that the service is not subscribed to. The service providing method further includes making, by the first vehicle terminal of the vehicle, a request to a service server for the service subscription information in response to the request of the second vehicle terminal. The service providing method further includes receiving, by the first vehicle terminal of the vehicle, the service subscription information. The service providing method further includes providing, by the first vehicle terminal, the service subscription information to the second vehicle terminal.

According to an embodiment, the service providing method may further include determining, by the second vehicle terminal, whether the service is subscribed to, based on the service subscription information.

According to an embodiment, the service subscription information may include subscription state information and plan information, or non-subscription state information and service subscription guidance information. The service providing method may further include determining, by the second vehicle terminal, whether the service is subscribed to, based on whether the service subscription information includes the subscription state information or the non-subscription state information.

According to an embodiment, the service providing method may further include providing, by the second vehicle terminal, the connected-car service based on plan information included in the service subscription information in response to a determination that the service is subscribed to.

According to an embodiment, the service providing method may further include giving, by the second vehicle terminal, guidance on a service subscription based on service subscription guidance information included in the service subscription information in response to a determination that the service is not subscribed to.

According to an embodiment, the service providing method may further include making, by the first vehicle terminal, a request to the service server for the service subscription information in response to a reset. The service providing method further includes receiving, by the first vehicle terminal, the service subscription information from the service server by the request. The service providing method further includes providing, by the first vehicle terminal, the received service subscription information to the second vehicle terminal.

According to an embodiment of the present disclosure, a vehicle service providing system includes a service server configured to perform a service opening and subscription for a vehicle. The vehicle service providing system further includes a content server configured to provide various types of content. The vehicle service providing system further includes a vehicle including a first vehicle terminal and a second vehicle terminal. The first vehicle terminal is configured to provide the second vehicle terminal with service subscription information received from the service server by request according to a preset situation. The second vehicle terminal is configured to communicate with the content server. The second vehicle terminal is further configured to determine whether a service for the vehicle is subscribed to, based on the service subscription information in response to a determination that there is a service request. The second vehicle terminal is further configured to provide a connected-car service based on communication with the content server or make a request to the first vehicle terminal for the service subscription information based on whether the service is subscribed to.

According to an embodiment, the service server may be configured to store a vehicle identification number and the service subscription information matched to each other. The first vehicle terminal may be configured to provide the vehicle identification number of the vehicle when making a request to the service server for the service subscription information. The service server may be configured to provide the first vehicle terminal with the service subscription information corresponding to the vehicle identification number.

According to an embodiment, the first vehicle terminal may be configured to request the service subscription information to the service server in response to the request of the second vehicle terminal. The first vehicle terminal may be further configured to receive the service subscription information from the service server. The first vehicle terminal may be further configured to provide the second vehicle terminal with the service subscription information received from the service server.

According to an embodiment, the first vehicle terminal may be configured to make a request to the service server for the service subscription information in response to a reset. The first vehicle terminal may be further configured to receive the service subscription information from the service server. The first vehicle terminal may be further configured to provide the received service subscription information to the second vehicle terminal.

According to an embodiment, the service server may be configured to perform the service opening and subscription for the vehicle in response to a request of a user request transmitting device. The service server may be further configured to provide the first vehicle terminal with service opening information and the service subscription information. The first vehicle terminal may be configured to provide the second vehicle terminal with the service opening information and the service subscription information.

According to an embodiment, the user request transmitting device may include the first vehicle terminal.

According to an embodiment of the present disclosure, a vehicle service providing method includes opening, by a service server, a service in response to a determination that a service opening for a vehicle is requested. The vehicle service providing method further includes determining, by a second vehicle terminal, whether a service for the vehicle is subscribed to in response to a determination that there is a service request. The vehicle service providing method further includes providing, by the second vehicle terminal, a connected-car service based on communication with a content server or making a request to a first vehicle terminal for service subscription information depending on whether the service is subscribed to.

According to an embodiment, the vehicle service providing method may further include making, by the first vehicle terminal, a request to the service server for the service subscription information in response to the request of the second vehicle terminal. The vehicle service providing method may further include receiving, by the first vehicle terminal, the service subscription information from the service server. The vehicle service providing method may further include providing, by the first vehicle terminal, the service subscription information to the second vehicle terminal.

According to an embodiment, the vehicle service providing method may further include storing, by the service server, a vehicle identification number and the service subscription information matched to each other. Making the request to the service server for the service subscription information by the first vehicle terminal may include providing the vehicle identification number of the vehicle. The vehicle service providing method may further include providing, by the service server, the first vehicle terminal with the service subscription information corresponding to the vehicle identification number.

Specific details according to various examples of the present disclosure, in addition to the means of solving the above-mentioned problems, are included in the following description and drawings.

Using a vehicle service providing technology according to an embodiment of the present disclosure, the latest service subscription guidance information can be provided without changing the software of an infotainment terminal (a second vehicle terminal of an embodiment).

This eliminates the need to change the software of the infotainment terminal every time service subscription guidance information is changed. Thus, development and maintenance costs may be reduced, and the latest service subscription guidance information may be efficiently provided.

In addition, every time a connected car terminal (a first vehicle terminal of an embodiment) is reset, service subscription information is obtained from a service server and provided to an infotainment terminal. Thus, a vehicle can provide a connected-car service based on the latest service subscription information.

Effects that may be obtained from the present disclosure should not be limited to only the above described effects. In addition, other effects, which are not described herein, should become apparent to those having ordinary skill in the art from the following descriptions.

The details of the problems to be solved, the means of solving the problems, and the effects mentioned above may specify non-essential features of the claims, and therefore the scope of the claims is not limited by the descriptions.

### BRIEF DESCRIPTION OF THE DRAWINGS

The accompanying drawings are intended to provide a better understanding of embodiments of the present disclosure and illustrate the embodiments with a detailed description. However, the technical features of the present embodiments are not limited to any particular drawings, and the features disclosed in each drawing may be combined with each other to form new embodiments.

FIG. 1 is a diagram illustrating a configuration of a vehicle service providing system according to an embodiment of the present disclosure.

FIG. 2 is a diagram illustrating a method of providing service opening information to a second vehicle terminal 200 according to an embodiment of the present disclosure.

FIG. 3 is a diagram illustrating a method of providing service subscription information to a second vehicle terminal 200 when a service is subscribed to according to an embodiment of the present disclosure.

FIG. 4 is a diagram illustrating a method of providing service subscription information to a second vehicle terminal 200 when a first vehicle terminal 100 is reset according to an embodiment of the present disclosure.

FIG. 5 is a diagram illustrating a method of providing service subscription information to a second vehicle terminal 200 when the second vehicle terminal 200 makes a request according to an embodiment of the present disclosure.

FIG. 6 is a diagram illustrating a vehicle service providing method according to an embodiment of the present disclosure.

### DETAILED DESCRIPTION

Advantages and features of the present disclosure and methods to achieve the advantages and features should be apparent from the following embodiments that are described in detail with reference to the accompanying drawings. It should be understood that the present disclosure is not limited to the following embodiments and may be embodied in different ways. It should be understood that the embodiments are given to provide descriptions of the present disclosure and to provide a thorough understanding of the present disclosure to those having ordinary skill in the art. The scope of the present disclosure is defined only by the claims.

The shapes, sizes, proportions, angles, numbers, etc. shown in the drawings to describe the embodiments of the present disclosure are exemplary, and the present disclosure is not limited to those shown. Throughout the present disclosure, the same reference numerals refer to same or equivalent elements. In addition, when the present disclosure is described, if it is decided that a detailed description of the known art related to the present disclosure makes the subject matter of the present disclosure unclear, the detailed description has been omitted. The terms, such as “including”, “having”, and “consist of” used herein, are generally intended to allow other components to be added unless the terms are used with the term “only”. The terms of a singular form may include plural forms unless specifically stated otherwise.

In construing an element, the element is construed as including an error range although there is no explicit description.

In describing a time relationship, when the temporal order relationship is described using the terms, such as “after”, “subsequent to”, “next”, and “before”, a case, which is not continuous, may be included unless the term “immediately” or “directly” is used.

It should be further understood that the terms first, second, and the like may be used to describe various elements, but these elements are not limited by these terms. These terms are only used to distinguish one element from another element. For instance, a first element discussed below could be termed as a second element without departing from the technical scope of the present disclosure.

In describing elements of the present disclosure, the terms, such as first, second, A, B, (a), (b), etc., may be used. The terms are only for differentiating one element from the other and are not intended to imply or suggest the substances, order, sequence, or number of the elements. If an element is described as being “connected”, “coupled”, or “linked” to another element, it should be understood that the elements may be directly connected or linked to each other, or interposing or intervening elements may be placed between the elements. In other words, the elements may be indirectly connected or linked to each other unless specifically stated otherwise.

It should be understood that the expression “at least one” includes all combinations of one or more of the related elements. For example, the meaning of “at least one of first, second, and third elements” may include a first, a second, or a third element as well as any combination of two or more of the first, second, and third elements.

Features of different embodiments of the present disclosure can be partially or entirely coupled to or combined with each other. The features of different embodiments of the present disclosure can variously inter-operate with each other and be driven technically. The embodiments of the present disclosure can be performed independently from each other or can be performed together in co-dependent relationship.

The scales of the elements shown in the drawings are different from the actual scales for convenience of description, so no limitation to the scales shown in the drawings is imposed.

Hereinafter, a vehicle, a service providing method thereof, and a vehicle service providing system and method including the same according to embodiments of the present disclosure are described with reference to the accompanying drawings. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

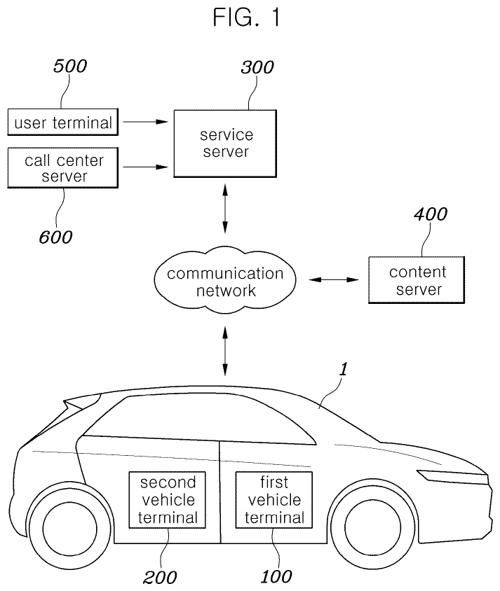

FIG. 1 is a diagram illustrating a configuration of a vehicle service providing system according to an embodiment of the present disclosure.

Referring to FIG. 1, a vehicle service providing system according to an embodiment of the present disclosure may include a first vehicle terminal 100 and a second vehicle terminal 200 provided in a vehicle 1, a service server 300, and a content server 400. The configuration of the vehicle service providing system is not limited thereto.

The vehicle 1 is linked to the service server 300 and may provide various connected-car services based on service opening information and service subscription information provided from the service server 300. For example, the vehicle 1 may be expressed as a “connected car”.

For example, the service opening information may include a transmitting number that is used for communication of the first vehicle terminal 110. For example, the service subscription information may include information on whether a connected-car service is subscribed to, a service brand name, a phone app brand name, a service plan, a call center name, a call center phone number, and a service website address.

The vehicle 1 may access a communication network based on the service opening information and may access the content server 400 to provide a connected-car service corresponding to the service subscription information.

For example, as the communication network, a wireless Internet technology, such as a wireless LAN (WLAN), Wi-Fi, wireless broadband (Wibro), and/or Worldwide Interoperability for Microwave Access (Wimax), a short-range communication technology, such as Bluetooth, near-field communication (NFC), radio-frequency identification (RFID), and/or infrared communication (IrDA, infrared Data Association), and/or a mobile communication technology, such as code-division multiple access (CDMA), Global System for Mobile communication (GSM), long-term evolution (LTE), LTE-Advanced, and/or International Mobile Telecommunications (IMT)-2020, may be used.

The vehicle 1 may give guidance on a service subscription based on service subscription guidance information received from the service server 300.

For example, when there is a connected-car service request from a user, the vehicle 1 may determine whether a connected-car service is subscribed to. When the connected-car service is not subscribed to, the vehicle 1 may give guidance on a service subscription.

The vehicle 1 may include the first vehicle terminal 100 and the second vehicle terminal 200 to provide a connected-car service.

For example, the first vehicle terminal 100 and the second vehicle terminal 200 may be linked to each other through vehicle network communication.

The first vehicle terminal 100 may be provided in a front seat of the vehicle 1 and may communicate with the service server 300 so that the vehicle 1 functions as a connected car. For example, the first vehicle terminal 100 may be expressed as a “vehicle front-seat terminal” or a “connected car terminal”.

The second vehicle terminal 200 may be provided in a back seat of the vehicle 1 and may communicate with the content server 400 so that the vehicle 1 provides a connected-car service. For example, the second vehicle terminal 200 may be expressed as a “vehicle back-seat terminal” or an “infotainment terminal”.

The first vehicle terminal 100 may receive service opening information provided from the service server 300 and may provide the service opening information to the second vehicle terminal 200.

The first vehicle terminal 100 may receive service subscription information and service subscription guidance information provided from the service server 300. The first vehicle terminal 100 may provide the service subscription information and the service subscription guidance information to the second vehicle terminal 200.

According to an embodiment, the first vehicle terminal 100 may make a request to the service server 300 for a service opening at the request of a user and may request a service subscription.

For example, the first vehicle terminal 100 may provide a vehicle identification number when a service opening or a service subscription is requested.

When the first vehicle terminal 100 is reset, the first vehicle terminal 100 may make a request to the service server 300 for service subscription information and may receive the service subscription information provided from the service server 300 in response to the request.

The first vehicle terminal 100 may receive service subscription information and service subscription guidance information together. The first vehicle terminal 100 may provide the received service subscription information and service subscription guidance information to the second vehicle terminal 200.

When there is a request from the second vehicle terminal 200, the first vehicle terminal 100 may make a request to the service server 300 for service subscription information and may receive the service subscription information provided from the service server 300 in response to the request. The first vehicle terminal 100 may receive service subscription information and service subscription guidance information together.

The first vehicle terminal 100 may provide the received service subscription information and service subscription guidance information to the second vehicle terminal 200.

For example, the first vehicle terminal 100 may provide a vehicle identification number when service subscription information is requested.

For example, when a service subscription or service subscription information is requested, the first vehicle terminal 100 may perform communication based on service opening information.

For example, the first vehicle terminal 100 may include a communication module (or communication modem) communicating with the service server 300, a communication module communicating with the second vehicle terminal 200, an algorithm or data for the operation of the first vehicle terminal 100, at least one memory storing information generated or obtained according to the operation of the first vehicle terminal 100, and at least one processor performing a vehicle service-related operation of the first vehicle terminal 100.

For example, a processor may be a hardware-implemented data processing device having a circuit with a physical structure for executing desired operations. For example, the desired operations may include code or instructions included in a program.

For example, examples of the hardware-implemented data processing device may include a microprocessor, a central processing unit, a processor core, a multi-core processor, a multiprocessor, an application-specific integrated circuit (ASIC), and a field programmable gate array (FPGA).

For example, a memory may be realized as at least one of the storage media (recording media), such as a flash memory, a hard disk, a secure digital card (SD card), a random-access memory (RAM), a static random-access memory (SRAM), a read-only memory (ROM), a programmable read-only memory (PROM), an electrically erasable and programmable ROM (EEPROM), an erasable and programmable ROM (EPROM), a register, a removable disk, or a web storage.

According to an embodiment, the second vehicle terminal 200 may receive service opening information, service subscription information, and service subscription guidance information from the first vehicle terminal 100.

The second vehicle terminal 200 may be linked to the content server 400 and may provide a connected-car service based on various types of content provided by the content server 400.

The second vehicle terminal 200 may access the communication network based on the service opening information and may access the content server 400 to provide a connected-car service corresponding to the service subscription information.

According to an embodiment, when there is a service request, the second vehicle terminal 200 may access the content server 400 to provide a connected-car service based on the service subscription information.

When there is a service request, the second vehicle terminal 200 may determine, based on service subscription information, whether a service is subscribed to and may provide a connected-car service when the service is subscribed to.

The second vehicle terminal 200 may determine whether a service is subscribed to. When the service is not subscribed to, the second vehicle terminal 200 may give guidance on a service subscription based on service subscription guidance information.

According to an embodiment, the second vehicle terminal 200 may give guidance on a service subscription based on pre-stored service subscription guidance information.

According to an embodiment, when the second vehicle terminal 200 determines that a service is not subscribed to, the second vehicle terminal 200 may make a request to the first vehicle terminal 100 for service subscription information. In response to the request for the service subscription information, the second vehicle terminal 200 may receive the service subscription information and service subscription guidance information provided from the first vehicle terminal 100.

In addition, the second vehicle terminal 200 may determine, based on service subscription, whether a service is subscribed to information. When a service is subscribed to, the second vehicle terminal 200 may provide a connected-car service. When the service is not subscribed to, the second vehicle terminal 200 may give guidance on a service subscription based on service subscription guidance information.

In this way, when the second vehicle terminal 200 gives guidance on a service subscription based on newly provided service subscription guidance information, the guidance to which updated information is applied is given. Thus, the user may be provided with accurate and up-to-date information.

For example, the second vehicle terminal 200 may include a communication module communicating with the content server 400, a communication module communicating with the first vehicle terminal 100, an algorithm or data for the operation of the second vehicle terminal 200, at least one memory storing information generated or obtained according to the operation of the second vehicle terminal 200, and at least one processor performing a vehicle service-related operation of the second vehicle terminal 200.

According to an embodiment, the service server 300 may open a connected-car service according to a connected-car service opening request and may provide service opening information to the first vehicle terminal 100.

For example, the service server 300 may receive a service opening request from at least one of the first vehicle terminal 100, a user terminal 500, or a call center server 600. For example, the service server 300 may receive a connected-car service opening request and a vehicle identification number together. The vehicle identification number may be used to determine which vehicle's vehicle terminal the service server 300 provides service opening information to.

The service server 300 may process a connected-car service subscription according to a connected-car service subscription request and may provide service subscription information to the first vehicle terminal 100. For example, the service server 300 may provide service subscription information and service subscription guidance information together.

For example, the service server 300 may receive a service subscription request from at least one of the first vehicle terminal 100, the user terminal 500, or the call center server 600. For example, the service server 300 may receive a service subscription request and a vehicle identification number together. The vehicle identification number may be used to determine which vehicle's vehicle terminal the service server 300 provides service subscription information to.

The service server 300 may match a vehicle identification number and service subscription information and store the same in the form of a look-up table (LUT).

For example, the service server 300 may include at least one communication module communicating with external devices, at least one memory storing an algorithm or data for the operation of the service server 300, at least one database storing information generated or obtained according to the operation of the service server 300, and at least one processor performing a vehicle service-related operation of the service server 300.

According to an embodiment, the content server 400 may be realized to provide various types of content.

The content server 400 may provide the second vehicle terminal 200 with the content requested by the second vehicle terminal 200 accessing the content server 400.

For example, the content server 400 may include a YouTube server providing YouTube, an over-the-top (OTT) server providing OTT services, such as Netflix and Disney+, and a music server providing music streaming services, such as Genie and Melon.

For example, the content server 400 may include at least one communication module communicating with external devices, at least one memory storing an algorithm or data for the operation of the content server 400, at least one database storing various types of content provided by the content server 400, and at least one processor performing a vehicle service-related operation of the content server 400.

According to an embodiment, the user terminal 500 and the call center server 600 may make a request to the service server 300 for a service opening at the request of a user.

The user terminal 500 and the call center server 600 may make a request to the service server 300 for a service subscription at the request of a user.

For example, the user terminal 500 and the call center server 600 may provide a vehicle identification number to the service server 300 when a service opening or a service subscription is requested.

According to an embodiment, the first vehicle terminal 100, the user terminal 500, and the call center server 600 are the elements for making a request to the service server 300 for a service opening and subscription at the request of a user. The first vehicle terminal 100, the user terminal 500, and the call center server 600 may be expressed as “user request transmitting devices”.

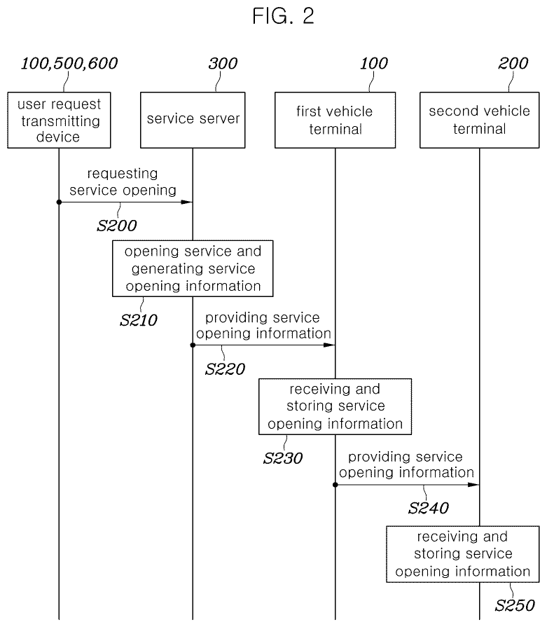

FIG. 2 is a diagram illustrating a method of providing service opening information to a second vehicle terminal 200 according to an embodiment of the present disclosure.

Referring to FIG. 2, a user request transmitting device 100, 500, or 600 may make a request to a service server 300 for a service opening at the request of a user in step S200.

For example, the user request transmitting device 100, 500, or 600 may be a first vehicle terminal 100, a user terminal 500, or a call center server 600.

In step S200, the user request transmitting device 100, 500, or 600 may provide a vehicle identification number related to a vehicle 1 when a service opening is requested.

Then, the service server 300 may open a connected-car service related to the vehicle 1 and may generate service opening information in step S210.

For example, the service opening information may include a transmitting number related to the vehicle 1.

Then, the service server 300 may provide the service opening information to the first vehicle terminal 100 in step S220.

Then, the first vehicle terminal 100 may receive and store the service opening information provided from the service server 300 in step S230 and may provide the service opening information to the second vehicle terminal 200 in step S240.

The second vehicle terminal 200 may receive and store the service opening information provided from the first vehicle terminal 100 in step S250.

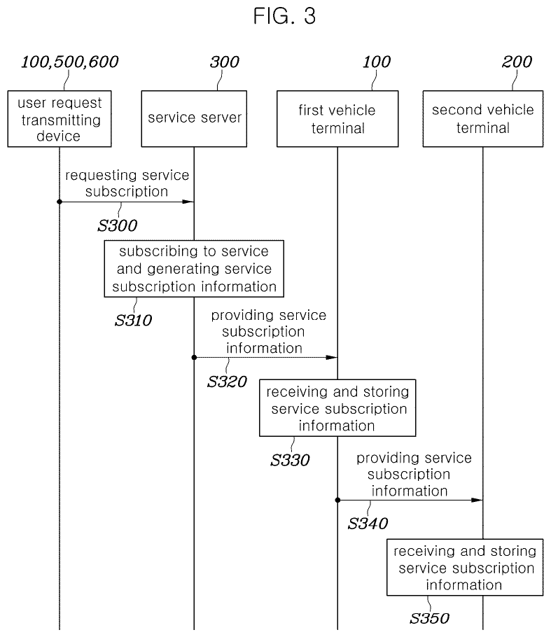

FIG. 3 is a diagram illustrating a method of providing service subscription information to a second vehicle terminal 200 when a service is subscribed to according to an embodiment of the present disclosure.

Referring to FIG. 3, a user request transmitting device 100, 500, or 600 may make a request to a service server 300 for a service subscription at the request of a user in step S300.

For example, the user request transmitting device 100, 500, or 600 may be a first vehicle terminal 100, a user terminal 500, or a call center server 600.

In step S300, the user request transmitting device 100, 500, or 600 may provide a vehicle identification number related to a vehicle 1 when a service subscription is requested.

Then, the service server 300 may process a connected-car service subscription related to the vehicle 1 and may generate service subscription information in step S310.

For example, the service subscription information may include information on whether a connected-car service is subscribed to, a service brand name, a phone app brand name, a plan, a call center name, a call center phone number, and a service website address.

Then, the service server 300 may provide the service subscription information to the first vehicle terminal 100 in step S320.

Then, the first vehicle terminal 100 may receive and store the service subscription information provided from the service server 300 in step S330 and may provide the service subscription information to the second vehicle terminal 200 in step S340.

The second vehicle terminal 200 may receive and store the service subscription information provided from the first vehicle terminal 100 in step S350.

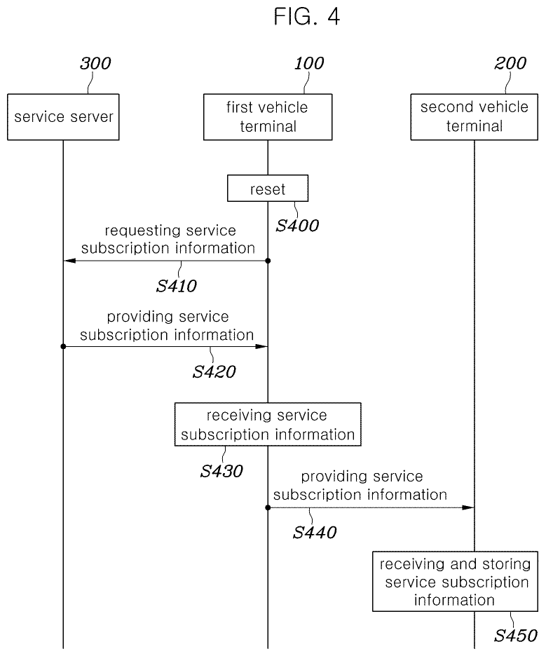

FIG. 4 is a diagram illustrating a method of providing service subscription information to a second vehicle terminal 200 when a first vehicle terminal 100 is reset according to an embodiment of the present disclosure.

Referring to FIG. 4, when the first vehicle terminal 100 is reset in step S400, the first vehicle terminal 100 may make a request to a service server 300 for service subscription information in step S410.

In step S410, the first vehicle terminal 100 may provide a vehicle identification number of a vehicle 1.

Then, the service server 300 may determine the service subscription information based on the vehicle identification number and may provide the service subscription information to the first vehicle terminal 100 in step S420.

The first vehicle terminal 100 may receive the service subscription information provided from the service server 300 in step S430 and may provide the received service subscription information to the second vehicle terminal 200 in step S440.

The second vehicle terminal 200 may receive and store the service subscription information provided from the first vehicle terminal 100 in step S450.

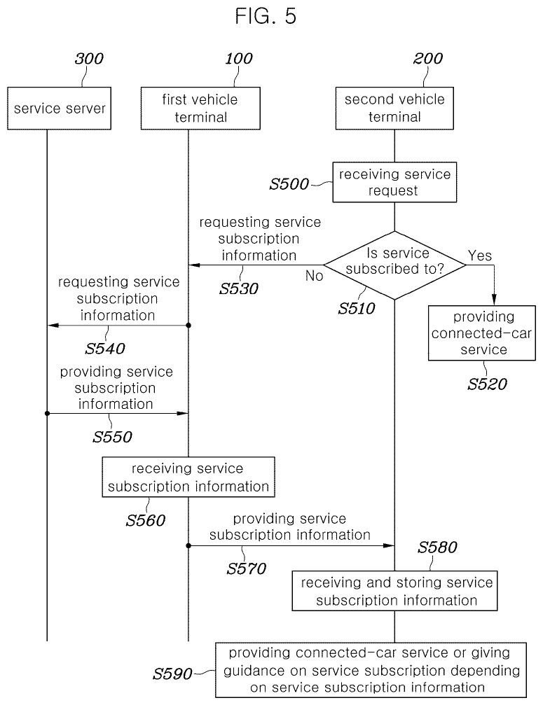

FIG. 5 is a diagram illustrating a method of providing service subscription information to a second vehicle terminal 200 when the second vehicle terminal 200 makes a request according to an embodiment of the present disclosure.

Referring to FIG. 5, when receiving a service request in step S500, the second vehicle terminal 200 may determine whether a service for a vehicle 1 is subscribed to in step S510.

In step S510, the second vehicle terminal 200 may determine whether plan information is stored. When there is plan information, it is determined that the service is subscribed to. When there is no plan information, it may be determined that the service is not subscribed to.

When the service is subscribed to in step S510—Yes, the second vehicle terminal 200 may provide a connected-car service based on the plan information in step S520.

Conversely, when the service is not subscribed to in step S510—No, the second vehicle terminal 200 may make a request to the first vehicle terminal 100 for service subscription information in step S530.

In response to the request for the service subscription information from the second vehicle terminal 200, the first vehicle terminal 100 may make a request to the service server 300 for the service subscription information in step S540.

For example, when the service subscription information is requested, the first vehicle terminal 100 may provide the vehicle identification number of the vehicle 1.

The service server 300 may determine the service subscription information based on the vehicle identification number and may provide the service subscription information to the first vehicle terminal 100 in step S550.

The first vehicle terminal 100 may receive the service subscription information provided from the service server 300 in step S560 and may provide the received service subscription information to the second vehicle terminal 200 in step S570.

Accordingly, the second vehicle terminal 200 may receive and store the service subscription information provided from the first vehicle terminal 100 in step S580.

According to an embodiment, the service subscription information may include subscription state information and plan information when the service for the vehicle 1 is subscribed to or may include non-subscription state information and service subscription guidance information when the service for the vehicle 1 is not subscribed to.

After step S580, the second vehicle terminal 200 may provide a connected-car service or give guidance on a service subscription based on the service subscription information in step S590.

According to an embodiment, the second vehicle terminal 200 may provide the connected-car service corresponding to the plan information and may give guidance on a service subscription based on the service subscription guidance information.

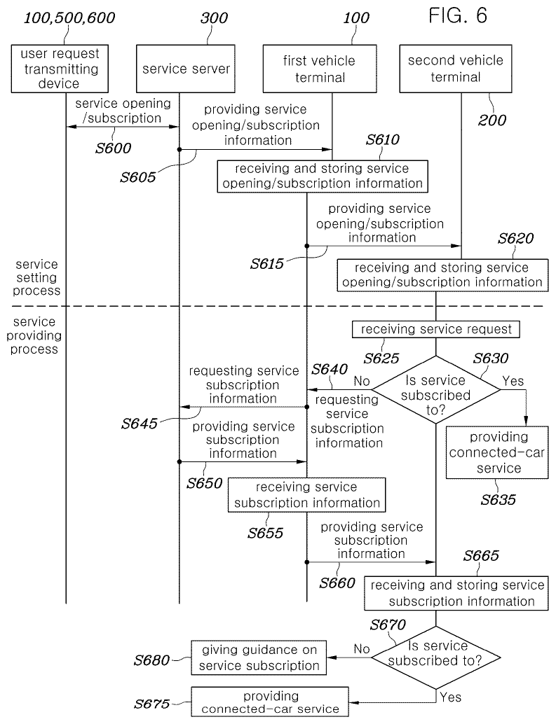

FIG. 6 is a diagram illustrating a vehicle service providing method according to an embodiment of the present disclosure.

Referring to FIG. 6, at the request of a user, a service opening and subscription may be made between a user request transmitting device 100, 500, or 600 and a service server 300 in step S600.

Then, the service server 300 may provide the first vehicle terminal 100 with service opening information generated at the time of a service opening and with service subscription information generated at the time of a service subscription in step S605.

The first vehicle terminal 100 may receive and store the service opening/subscription information provided from the service server 300 in step S610 and may provide the service opening/subscription information to the second vehicle terminal 200 in step S615.

The second vehicle terminal 200 may receive and store the service opening/subscription information provided from the first vehicle terminal 100 in step S620.

Although not shown in FIG. 6, when the first vehicle terminal 100 is reset, the first vehicle terminal 100 may provide the latest service subscription information to the second vehicle terminal 200 through the process as shown in FIG. 4.

Steps S600 to S625 relate to presetting to receive a connected-car service, and after the service opening and subscription, the vehicle 1 may receive the connected-car service.

In the meantime, steps S625 to S680 after step S620 may correspond to a process of providing the vehicle 1 with the connected-car service.

The service setting process S600 to S620 and the service providing process S625 to S680 are shown together in FIG. 6 for ease of description, but the service request is not necessarily received after the service opening/subscription information is stored in the second vehicle terminal 200.

Therefore, before receiving the service request in step S625, the second vehicle terminal 200 may or may not store the service subscription information.

Referring back to FIG. 6, when receiving a service request in step S625, the second vehicle terminal 200 may determine whether a service for the vehicle 1 is subscribed to in step S630.

In step S630, the second vehicle terminal 200 may determine whether plan information is stored. When there is plan information, it is determined that the service is subscribed to. When there is no plan information, it may be determined that the service is not subscribed to.

When the service is subscribed to in step S630—Yes, the second vehicle terminal 200 may provide a connected-car service based on the plan information in step S635.

Conversely, when the service is not subscribed to in step S630—No, the second vehicle terminal 200 may make a request to the first vehicle terminal 100 for service subscription information in step S640.

In response to the request for the service subscription information from the second vehicle terminal 200, the first vehicle terminal 100 may make a request to the service server 300 for the service subscription information in step S645.

For example, when the service subscription information is requested, the first vehicle terminal 100 may provide the vehicle identification number of the vehicle 1.

The service server 300 may determine the service subscription information based on the vehicle identification number and may provide the service subscription information to the first vehicle terminal 100 in step S650.

The first vehicle terminal 100 may receive the service subscription information provided from the service server 300 in step S655 and may provide the received service subscription information to the second vehicle terminal 200 in step S660.

Accordingly, the second vehicle terminal 200 may receive and store the service subscription information provided from the first vehicle terminal 100 in step S665.

According to an embodiment, the service subscription information may include subscription state information and plan information when the service for the vehicle 1 is subscribed to or may include non-subscription state information and service subscription guidance information when the service for the vehicle 1 is not subscribed to.

Then, the second vehicle terminal 200 may determine, based on the service subscription information, whether the vehicle 1 subscribes to a service in step S670.

In step S670, the second vehicle terminal 200 may determine whether the service subscription information includes the subscription state information or the non-subscription state information.

When it is determined that the vehicle 1 subscribes to the service in step S670—Yes, i.e., the service subscription information includes the subscription state information, the second vehicle terminal 200 may provide a connected-car service corresponding to the plan information included in the service subscription information in step S675.

When it is determined that the vehicle 1 does not subscribe to the service in step S670—No, i.e., the service subscription information includes the non-subscription state information, the second vehicle terminal 200 may give guidance on a service subscription based on the service subscription guidance information included in the service subscription information in step S680.

Embodiments of the present disclosure have been described in more detail with reference to the accompanying drawings. However, the present disclosure is not necessarily limited to the embodiments, and various modifications may be made without departing from the technical idea of the present disclosure. Accordingly, the embodiments disclosed in the present disclosure are intended to describe rather than limit the technical idea of the present disclosure, and the scope of the technical idea of the present disclosure is not limited by the embodiments. Therefore, it should be understood that the embodiments described above are illustrative in all aspects as and not restrictive. The scope of protection of the present disclosure should be construed by the scope of the claims, and all technical ideas within the scope equivalent thereto should be construed as falling within the scope of the rights of the present disclosure.

What is claimed is:

1. A vehicle, comprising:
a first vehicle terminal and a second vehicle terminal,
wherein the first vehicle terminal is configured to:
communicate with a service server; and
provide the second vehicle terminal with service subscription information received from the service server by request according to a preset situation, and
wherein the second vehicle terminal is configured to:
communicate with a content server;
determine whether a service for the vehicle is subscribed to, based on the service subscription information in response to a service request; and
provide a connected-car service based on communication with the content server in response to a determination that the service is subscribed to.

2. The vehicle according to claim 1, wherein the second vehicle terminal is further configured to make a request to the first vehicle terminal for the service subscription information in response to a determination that the service is not subscribed to.

3. The vehicle according to claim 2, wherein the first vehicle terminal is further configured to request the service subscription information to the service server in response to the request of the second vehicle terminal and provide the second vehicle terminal with the service subscription information received from the service server by request, and
wherein the second vehicle terminal is further configured to determine whether the service is subscribed to, based on the service subscription information.

4. The vehicle according to claim 3, wherein the second vehicle terminal is further configured to:
provide the connected-car service based on plan information included in the service subscription information in response to a determination that the service is subscribed to; and
give guidance on a service subscription based on service subscription guidance information included in the service subscription information in response to a determination that the service is not subscribed to.

5. The vehicle according to claim 1, wherein the first vehicle terminal is configured to:
make a request to the service server for the service subscription information in response to a reset;
receive the service subscription information from the service server by request; and
provide the received service subscription information to the second vehicle terminal.

6. A service providing method of a vehicle, the method comprising:
determining, by a second vehicle terminal of the vehicle, whether a service for the vehicle is subscribed to in response to a service request;
providing, by the second vehicle terminal, a connected-car service based on communication with a content server in response to a determination that the service is subscribed to;
making, by the second vehicle terminal, a request to a first vehicle terminal of the vehicle for service subscription information in response to a determination that the service is not subscribed to;
making, by the first vehicle terminal of the vehicle, a request to a service server for the service subscription information in response to the request of the second vehicle terminal;
receiving, by the first vehicle terminal, the service subscription information; and
providing, by the first vehicle terminal, the service subscription information to the second vehicle terminal.

7. The method according to claim 6, further comprising:
determining, by the second vehicle terminal, whether the service is subscribed to, based on the service subscription information.

8. The method according to claim 7, wherein the service subscription information includes subscription state information and plan information, or non-subscription state information and service subscription guidance information, and
wherein the method further comprises determining, by the second vehicle terminal, whether the service is subscribed to, based on whether the service subscription information includes the subscription state information or the non-subscription state information.

9. The method according to claim 7, further comprising:
providing, by the second vehicle terminal, the connected-car service based on plan information included in the service subscription information in response to a determination that the service is subscribed to.

10. The method according to claim 7, further comprising giving, by the second vehicle terminal, guidance on a service subscription based on service subscription guidance information included in the service subscription information in response to a determination that the service is not subscribed to.

11. The method according to claim 6, further comprising:
making, by the first vehicle terminal, a request to the service server for the service subscription information in response to a reset;
receiving, by the first vehicle terminal, the service subscription information from the service server by the request; and
providing, by the first vehicle terminal, the received service subscription information to the second vehicle terminal.

12. A vehicle service providing system, comprising:
a service server configured to perform a service opening and subscription for a vehicle;
a content server configured to provide various types of content; and
a vehicle including a first vehicle terminal and a second vehicle terminal,
wherein the first vehicle terminal is configured to provide the second vehicle terminal with service subscription information received from the service server by request according to a preset situation, and
wherein the second vehicle terminal is configured to:
communicate with the content server, determine whether a service for the vehicle is subscribed to, based on the service subscription information in response to a determination that there is a service request; and
provide a connected-car service based on communication with the content server or make a request to the first vehicle terminal for the service subscription information based on whether the service is subscribed to.

13. The system according to claim 12, wherein the service server is further configured to store a vehicle identification number and the service subscription information matched to each other,
wherein the first vehicle terminal is further configured to provide the vehicle identification number of the vehicle when making a request to the service server for the service subscription information, and
wherein the service server is further configured to provide the first vehicle terminal with the service subscription information corresponding to the vehicle identification number.

14. The system according to claim 12, wherein the first vehicle terminal is further configured to:
request the service subscription information to the service server in response to the request of the second vehicle terminal;
receive the service subscription information from the service server; and
provide the second vehicle terminal with the service subscription information received from the service server.

15. The system according to claim 12, wherein the first vehicle terminal is further configured to:
make a request to the service server for the service subscription information in response to a reset;
receive the service subscription information from the service server; and
provide the received service subscription information to the second vehicle terminal.

16. The system according to claim 12, wherein the service server is further configured to:
perform the service opening and subscription for the vehicle in response to a request of a user request transmitting device; and
provide the first vehicle terminal with service opening information and the service subscription information, and
wherein the first vehicle terminal is configured to provide the second vehicle terminal with the service opening information and the service subscription information.

17. The system according to claim 16, wherein the user request transmitting device includes the first vehicle terminal.
